(19) United States
(12) Patent Application Publication
(10) Pub. No.: US 2026/0200441 A1
(43) Pub. Date: Jul. 16, 2026

(54) TIRE INFLATION SYSTEM

(71) Applicant: INTERNATIONAL WHEEL & TIRE COMPANY, Farmington Hills, MI (US)

(72) Inventors: Todd Allen Campbell, LaSalle, MI (US); Don Lamos, Farmington Hills, MI (US); Ghanem Jandali, Farmington Hills, MI (US)

(21) Appl. No.: 19/134,855

(22) PCT Filed: Dec. 11, 2023
(86) PCT No.: PCT/US2023/083409

§ 371 Date: Jun. 2, 2025

Related U.S. Application Data
(60) Provisional application No. 63/431,872, filed on Dec. 12, 2022.

(51) Int. Cl. B60S 5/04

(52) U.S. Cl. CPC B60S 5/04

(57) ABSTRACT

An inflation system for wheel assemblies having tires and rims includes a primary inflator tool, a nest, and a secondary inflator tool. The primary and secondary inflator tools are configured to advance toward the wheel assemblies, engage the wheel assemblies, inflate the tires of the wheel assemblies, and retract from the wheel assemblies after inflating the tires. The nest is configured to transition between first and second positions. In the first position the nest is aligned with the primary inflator tool. In the second position the nest is offset from the primary inflator tool. The secondary inflator tool is configured to be positioned on the nesting fixture in an idle position. The secondary inflator tool is configured to be detachably coupled to the primary inflator tool in an operational position.

### CROSS-REFERENCE TO RELATED APPLICATIONS

This application claims the benefit of U.S. provisional application Ser. No. 63/431,872 filed Dec. 12, 2022, the disclosure of which is hereby incorporated in its entirety by reference herein.

### TECHNICAL FIELD

The present disclosure relates to automated systems for assembling wheels, particularly for the automobile industry. The automated systems for assembling wheels may include tire inflation stations that include bell-shaped tools configured to engage and inflate tires. The inflation stations may include multiple bell-shaped tools that may be interchangeable to accommodate differently sized tires.

### BACKGROUND

Automated systems may be utilized to assemble wheels, which may be subsequently installed onto automobiles.

### SUMMARY

An inflation system for wheel assemblies having tires and includes an inflation station, a nesting fixture, and a controller. The inflation station includes an overhead frame and a primary inflator tool. The primary inflator tool defines a first passage and is movably secured to the overhead frame. The nesting fixture is disposed adjacent to the inflation station and is configured to move into and out of the inflation station. A secondary inflator tool defines a second passage. The secondary inflator tool is configured to be positioned on the nesting fixture in an idle position. The secondary inflator tool is configured to be detachably coupled to the primary inflator tool in an operational position. The controller is programmed to, in response to a command to transition the secondary inflator tool from the idle position to the operational position, move the nesting fixture into the inflation station and couple the secondary inflator tool to the primary inflator tool.

An inflation system for wheel assemblies having tires and rims includes an inflation station a nesting fixture, and a controller. The inflation station includes an overhead frame and a primary inflator tool. The primary inflator tool defines a first passage and is movable secured to the overhead frame. The nesting fixture is disposed adjacent to the inflation station and is configured to move into and out of the inflation station. A secondary inflator tool defines a second passage. The secondary inflator tool is configured to be positioned on the nesting fixture in an idle position. The secondary inflator tool is configured to be detachably coupled to the primary inflator tool in an operational position. The controller is programmed to, in response to a command to transition the secondary inflator tool from the operational position to the idle position, move the nesting fixture into the inflation station and decouple the secondary inflator tool from the primary inflator tool.

An inflation system for wheel assemblies having tires and rims includes a primary inflator tool, a nest, a secondary inflator tool, and clamps. The primary inflator tool is configured to advance toward the wheel assemblies, engage the wheel assemblies, inflate the tires of the wheel assemblies, and retract from the wheel assemblies after inflating the tires. The nest is configured to transition between first and second positions. In the first position the nest is aligned with the primary inflator tool. In the second position the nest is offset from the primary inflator tool. The secondary inflator tool is configured to be positioned on the nesting fixture in an idle position. The secondary inflator tool is configured to be detachably coupled to the primary inflator tool in an operational position. The clamps are secured to the primary inflator tool and are configured to detachably couple the secondary inflator tool to the primary inflator tool.

### BRIEF DESCRIPTION OF THE DRAWINGS

FIG. 1 is a plan view of a wheel assembly system;

FIG. 2 is a front view of an inflation station and a corresponding tooling nesting system of the wheel assembly system;

FIG. 3 is a side view of the inflation station and the corresponding tooling nesting system;

FIG. 4 is a top view of the inflation station and the corresponding tooling nesting system;

FIG. 5 is an isometric view of the tooling nesting system;

FIG. 6 is a side view of the tooling nesting system;

FIG. 7 is a top view of the tooling nesting system;

FIG. 8 is a front view of the tooling nesting system;

FIG. 9 is a cross-sectional view taken along line 9-9 in FIG. 4 illustrating a primary inflator tool;

FIG. 10 is a cross-sectional view taken along line 9-9 in FIG. 4 illustrating the primary inflator tool and a secondary inflator tool, where the secondary inflator tool is secured to the primary inflator tool;

FIG. 11 is a cross-sectional view taken along line 9-9 in FIG. 4 illustrating an alternative configuration of the primary inflator tool and the secondary inflator tool, where the secondary inflator tool is secured to the primary inflator tool;

FIG. 12 is a flowchart illustrating a method of operating the inflator tools;

FIG. 13 is a flowchart illustrating a method of decoupling inflator tools; and

FIG. 14 is a flowchart illustrating a method of coupling inflator tools.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

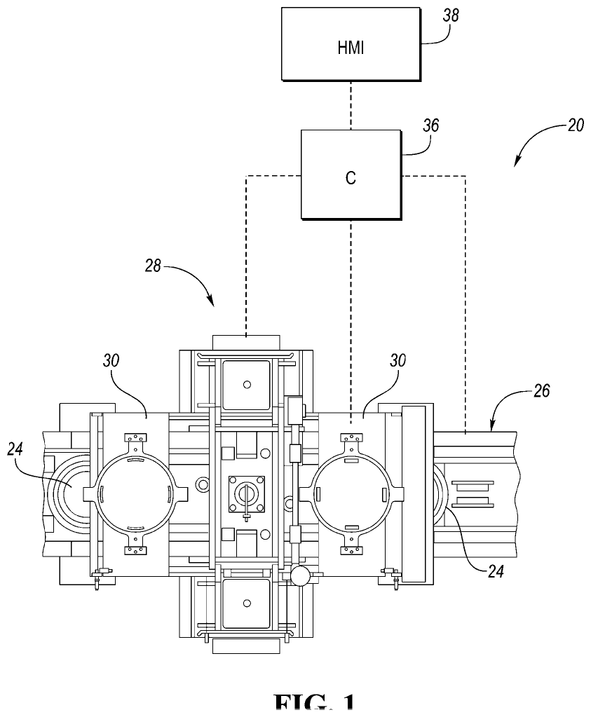

Referring to FIG. 1, a plan view of a wheel assembly line or wheel assembly system 20 is illustrated. The wheel assembly system 20 may include stations that perform various steps to assemble and prepare wheel assemblies for installation onto an automobile or other vehicle. The wheel assemblies may include both a tire and a rim. The wheel assembly system 20 illustrated in FIG. 1 may only include a portion of the wheel assembly system 20. The first station may be referred to as a mounter or mounting station. Prior to the mounting station, the tires of the wheel assemblies may be placed onto the corresponding rims of the wheel assemblies. The rims may be positioned on fixtures or pallets 24 of a conveyance system 26 that transfers the wheel assemblies to each station. However, conveyance of the wheel assemblies may be accomplished via any method. For example, the wheel assemblies may be transported to each station via a lift and transfer system, a pick and place system, a conveyor belt or track, etc. The mounting station may then fit the tires onto the corresponding rims in a deflated state. More specifically, the mounting station may include tooling that presses sidewalls of the tires into spaces defined between the outer flanges of the corresponding rim so that both sidewalls of the tires are inside the outer flanges of the corresponding rims.

Next, the wheel assemblies are transferred to an inflation station 28 via the conveyance system 26 where the tires are in inflated to a desired pressure. A tooling nesting system 30 is utilized to store additional tools for the inflation station 28 and may be positioned proximate or adjacent to the inflation station 28. The inflation station 28 and the tooling nesting system 30 may be collectively referred to as an inflation system. Once the tires of the wheel assemblies have been inflated, the wheel assemblies are transferred to an unload station via the conveyance system 26 where the wheel assemblies are unloaded from the wheel assembly system 20. The wheel assemblies may be offloaded from the wheel assembly system 20 at the unload station and loaded onto pallets. The loaded pallets may then be transferred to a final assembly line where the wheel assemblies are installed onto an automobile or other vehicle. Alternatively, the unload station may unload the wheel assemblies from the wheel assembly system 20 and directly onto another conveyance system that transports the wheel assemblies to the final assembly line.

The wheel assembly system 20 may include a controller 36 that is configured to control the operation of the various components of the wheel assembly system 20, such as the mounting station, conveyance system 26, inflation station 28, tooling nesting system 30, unload station, etc. The wheel assembly system 20 may also include a human machine interface (HMI) 38 that is configured to communicate with the controller 36. An operator may control the operation of the wheel assembly system 20 via an interface of the HMI 38. The interface of the HMI 38 may include buttons, knobs, dials, touchscreens, etc. Operation of the wheel assembly system 20 may include initiating operation of the wheel assembly system 20, halting operation of the wheel assembly system 20, clearing faults of the wheel assembly system 20, etc. Alternatively, each subsystem, subcomponent, or station of the wheel assembly system 20 (e.g., mounting station, conveyance system 26, inflation station 28, unload station, etc.) may include a separate HMI and/or a separate controller that communicates with a master controller to synchronize operation of all of the subsystems, subcomponents, or stations of the wheel assembly system 20.

While illustrated as one controller, the controller 36 may be part of a larger control system and may be controlled by various other controllers throughout the wheel assembly system 20. It should therefore be understood that the controller 36 and one or more other controllers can collectively be referred to as a “controller” that controls various actuators in response to signals from various sensors to control functions the wheel assembly system 20 or its subsystems. The controller 36 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 36 in controlling the wheel assembly system 20 or its subsystems.

Control logic or functions performed by the controller 36 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller, such as controller 36. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

The controller 36 may be configured to receive various states or conditions of the various vehicle components illustrated in FIG. 1 via electrical signals. The electrical signals may be delivered to the controller 36 from the various components via input channels. Additionally, the electrical signals received from the various components may be indicative of a request or a command to change or alter a state of one or more of the respective components of the wheel assembly system 20 or its subsystems. The controller 36 includes output channels that are configured to deliver requests or commands (via electrical signals) to the wheel assembly system 20 or its subsystems. The controller 36 includes control logic and/or algorithms that are configured to generate the requests or commands delivered through the output channels based on the requests, commands, conditions, or states of the wheel assembly system 20 or its subsystems.

It should be understood that the wheel assembly system 20 illustrated in FIG. 1 is not meant to be limiting and that the wheels assembly system 20 could include fewer or additional subsystems, subcomponents, or stations. For example, an error proofing station could be positioned between the mounting station and the inflation station 28. Such an error proofing station may include a vision system that inspects the tires and rims, where the vision system determines if the tires are properly installed onto the rims, that tires and corresponding rims are a proper match, etc. As another example, a marking station could be positioned between the mounting station and the inflation station 28. Such a marking station may label the wheel assemblies according to model or type. The labels may be printed onto the wheel assemblies or may be codes (e.g., barcodes, URL codes, etc.) that are stuck to the wheel assemblies.

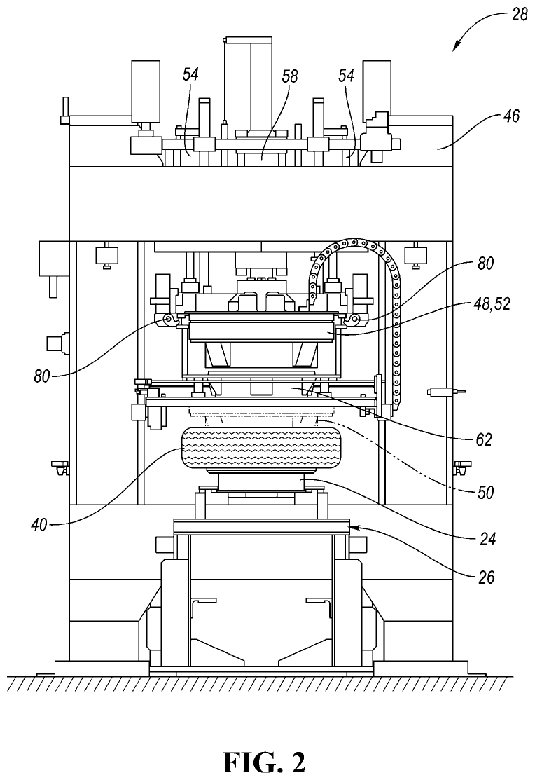

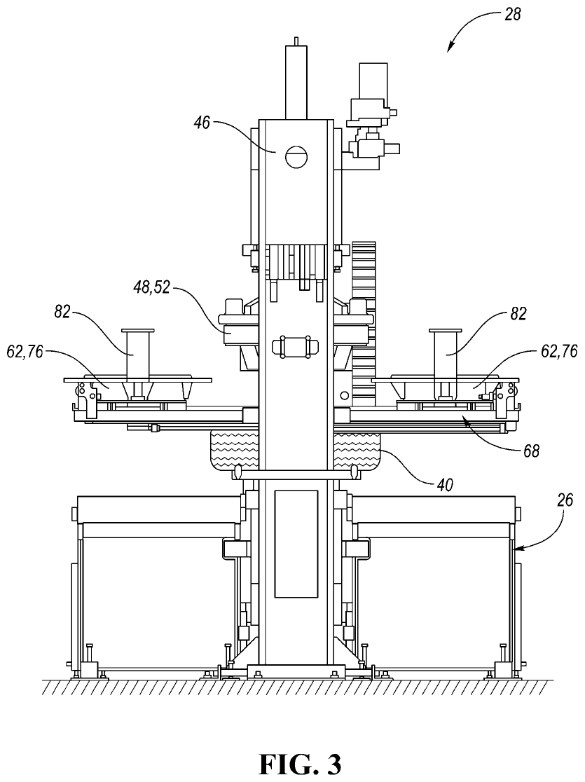

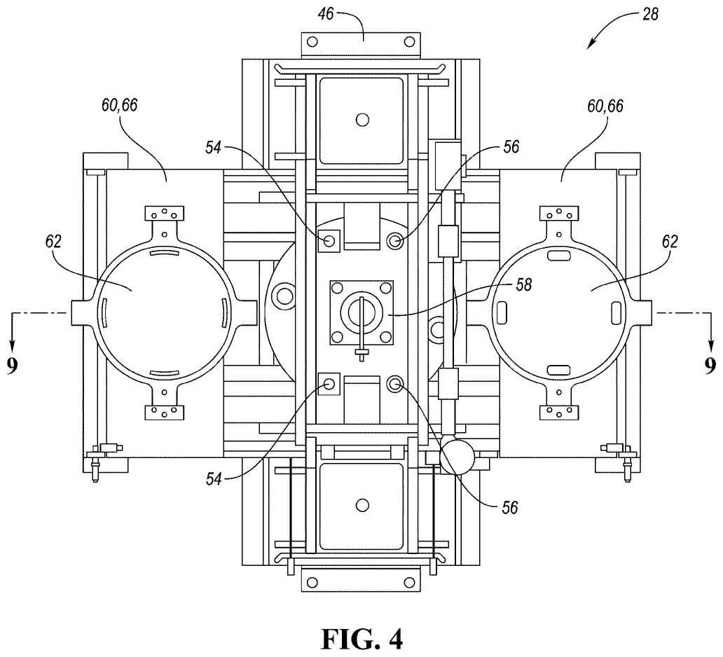

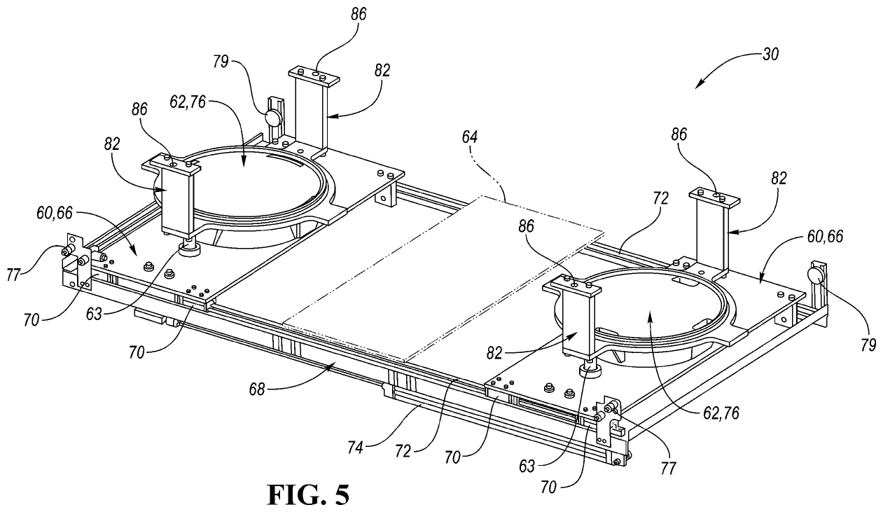

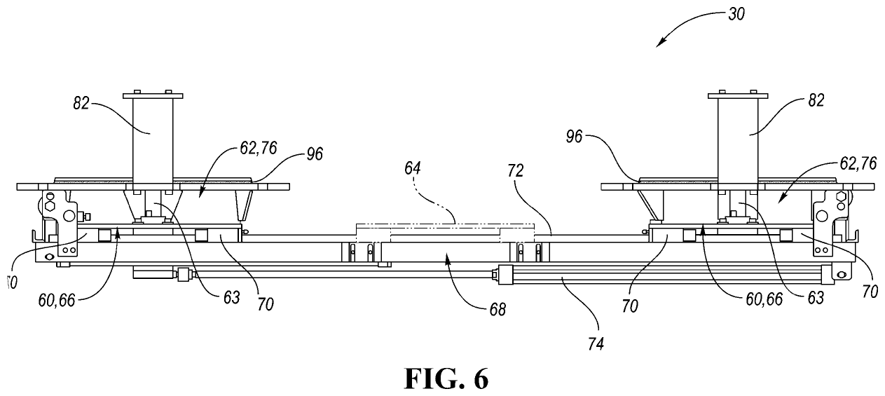

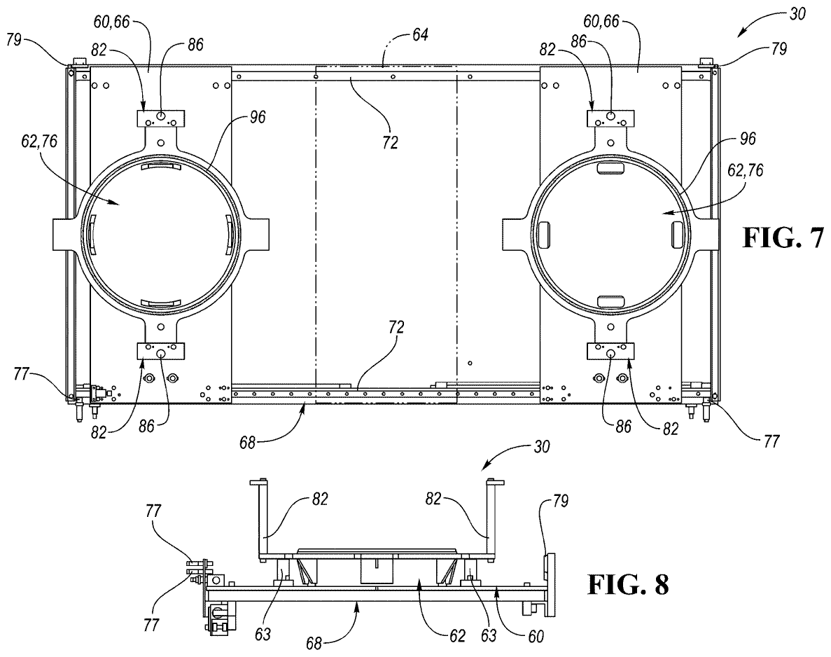

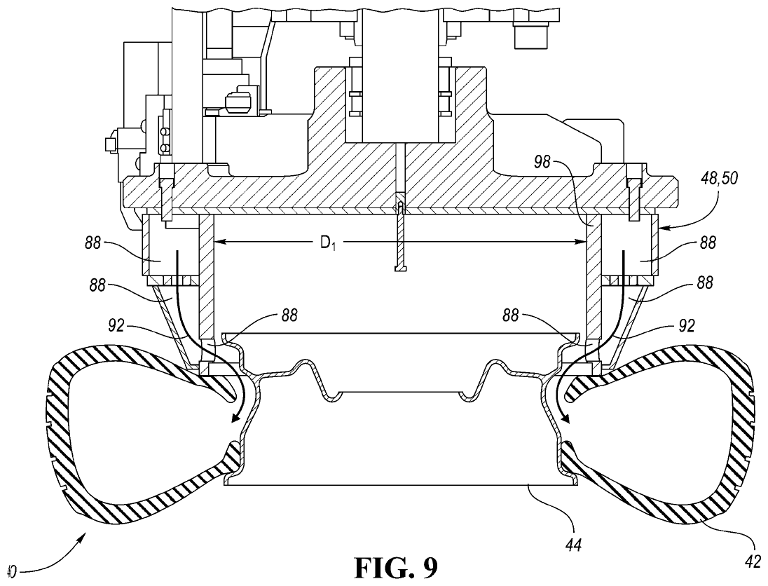

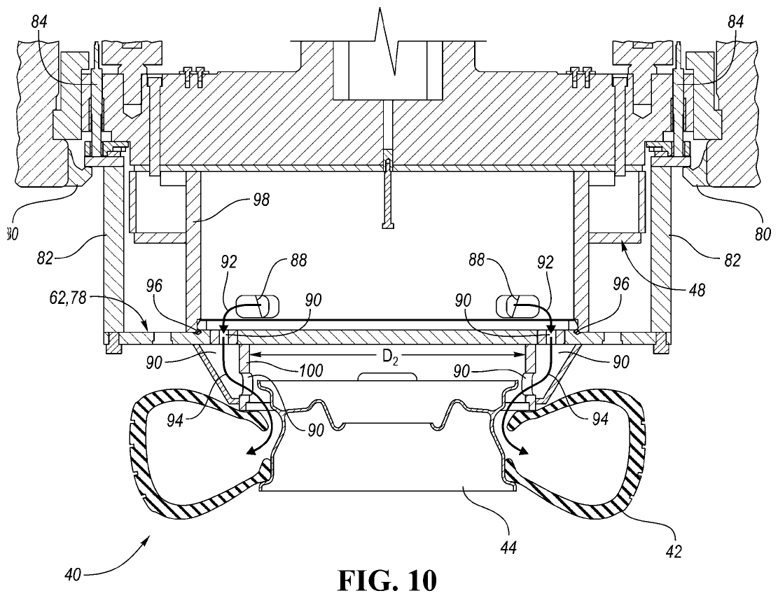

Referring to FIGS. 2-10, the inflation station 28 and the tooling nesting system 30 are illustrated in further detail. Wheel assemblies 40 that include tires 42 and rims 44 are illustrated in some of the figures. However, the wheel assemblies 40 have been omitted from some of the Figures for illustrated purposes. The inflation station 28 include an overhead frame 46 and a primary inflator tool 48. The primary inflator tool 48 is movably secure to the overhead frame 46. More specifically, the primary inflator tool 48 is configured to advance downward to a lower or engaged position 50 and toward the wheel assemblies 40, where the primary inflator tool 48 engages the wheel assemblies 40 to inflate the tires 42 to desired pressures. The primary inflator tool 48 is also configured to retract to an upward or disengaged position 52 to provide clearance for the wheel assemblies 40 after inflating the tires 42 so that the conveyance system 26 may transfer the inflated wheel assembly 40 out of the inflation station 28 and transfer the next wheel assembly 40 that requires inflation into the inflation station 28.

One or more actuators 54 (e.g., pneumatic cylinders) may be secured to the overhead frame 46 and may engage the primary inflator tool 48 to transition the primary inflator tool 48 between the engaged position 50 and the disengaged position 52. Linear guides 56 (e.g., a rod and bushing combination) may ensure the pathway of the primary inflator tool 48 between the engaged position 50 and the disengaged position 52 remains constant through each cycle. A secondary actuator 58 (e.g., a hydraulic cylinder) may be secured to the overhead frame 46 and may engage the primary inflator tool 48 to provide a reaction force to maintain the primary inflator tool 48 in the engaged position 50 while the tires 42 are being inflated. Such an actuator that provides a reaction force counteracts the force cause by the air pressure while the tires 42 are being inflated. An air compressor (not show) supplies the pressurized air to the primary inflator tool 48. The one or more actuators 54 and secondary actuator 58 may be in communication with and controlled by the controller 36.

The tooling nesting system 30 include one or more nesting fixtures or nests 60 that are configured to support secondary inflator tools 62. The nests 60 may more specifically include pins 63 that are configured to locate the secondary inflator tools 62 in a desired position with respect to the corresponding nests 60 that the secondary inflator tools 62 are positioned on. One of the pins 63 may be a round-shaped pin while the other pin 63 is a diamond-shaped pin. Such a combination of a round-shape pin and a diamond-shaped pin restrict movement of the object engaging the pins and reduces variation in position of the object engaging the pins. Each nest 60 is disposed adjacent to the inflation station 28 and is configured to move into and out of the inflation station 28. More specifically, each nest 60 is configured to move into a first or advanced position 64 where the nest 60 is aligned with the primary inflator tool 48 and a second or retracted position 66 where the nest 60 is offset from the primary inflator tool 48. Each nest 60 may move into and out of the inflation station 28 in any manner. For example, each nest 60 may slide into and out of the inflation station 28, each nest 60 may roll into and out of the inflation station 28, a pick and place device may transport each nest 60 into and out the inflation station 28, etc. Alignment between one of the nests 60 and the primary inflator tool 48 when the nest 60 is in the first or advanced position 64 may be a full or partially alignment along a vertically extending axis. An offset condition of one of the nests 60 and the primary inflator tool 48 when the nest 60 is in the second or retracted position 66 may correspond to a full or partially horizontal misalignment between the primary inflator tool 48 when the nest 60 such that either the primary inflator tool 48 or the nest 60 is not positioned on the vertically extending axis.

Each nest 60 may be movably coupled to a frame 68 via a linear guide system to ensure the pathway of the nests 60 relative to the frame 68 remains constant through each transition between the advanced positions 64 and the retracted positions 66. Such a linear guide system may comprise bearing blocks 70 that are secured to the bottom of the nests 60 and engage rails 72 that are secured to the frame 68. Actuators 74 (e.g., pneumatic cylinders) may be secured to the frame 68 and may engage the nests 60 to transition the nests between the advanced positions 64 and the retracted positions 66. The actuators 74 may be in communication with and controlled by the controller 36. Each of the secondary inflator tools 62 are configured to be positioned on a corresponding nest 60 in an idle position 76 and are detachably coupled to the primary inflator tool 48 in an operational position 78.

Sensors 77 may be secured to the frame 68 that are configured to detect the presence or absence of the secondary inflator tools 62 on the nests 60 (i.e., the secondary inflator tools 62 being in the idle positions 76) when the nests 60 are in the retracted positions 66. The sensors 77 may communicate the presence or absence of the secondary inflator tools 62 on the nests 60 to the controller 36. The sensors 77 may be optical sensors that direct a light beam to a reflector 79, which redirects the light beam back to the sensor 77. Breaks or obstructions in the light beams may be indicative that the secondary inflator tools 62 are present on the nests 60 while no breaks or obstructions in the light beams may be indicative that the secondary inflator tools 62 are not present on the nests 60.

It is noted that two nests 60 and two corresponding secondary inflator tools 62 are illustrated herein. Under such a configuration, one of the secondary inflator tools 62 may be referred to as the secondary inflator tool while the other is referred to as the tertiary inflator tool. Also, under such a configuration, the advanced position 64 of the tertiary inflator tool may be referred to as the third position while the retracted position 66 of the tertiary inflator tool may be referred to as the fourth position. Furthermore, under such a configuration the idle position 76 of the tertiary inflator tool (i.e., where the tertiary inflator tool is positioned on a corresponding nest 60) may be referred to as the second idle position while the operational position 78 of the tertiary inflator tool (i.e., where the tertiary inflator tool is detachably coupled to the primary inflator tool 48) may be referred to as the second operational position.

Clamps 80 are secured to the primary inflator tool 48 and are configured to detachably couple the secondary inflator tools 62 to the primary inflator tool 48. It is noted that only one of the secondary inflator tools 62 may be coupled to the primary inflator tool 48 at any given time. The secondary inflator tools 62 includes posts 82 extending upward therefrom. The clamps 80 are more specifically configured to engage and disengage the posts 82 to couple and decouple the secondary inflator tools 62 to and from the primary inflator tool 48. The clamps 80 may be in communication with and controlled by the controller 36.

Alignment elements may be utilized to ensure secondary inflator tools 62 are properly secured to and properly aligned with the primary inflator tool 48 when one of the secondary inflator tools 62 is being utilized. Additional elements may be utilized to determine if the secondary inflator tools 62 are present (e.g., connected to the primary inflator tool 48) when being utilized. For example, guide pins 84 may be secured to the primary inflator tool 48. A biasing element (e.g., a spring) may bias the guide pins 84 downward. The posts 82 may define locating orifices 86. The guide pins 84 may have ends or tips that are disposed within the locating offices 86 of one of the secondary inflator tools 62 when the secondary inflator tool 62 is coupled to the primary inflator tool 48. Shoulders of the guide pins 84 may engage top surfaces of the posts 82 when one of the secondary inflator tools 62 is coupled to the primary inflator tool 48. The top surfaces of the posts 82 engaging the shoulders on the guide pins 84 may push the guide pins 84 upward and displace the guide pins 84 over a desired distance.

Proximity sensors may detect whether or not the guide pins 84 have been not displaced, have been displaced by the desired distance, or have been displace by an undesired distance, which may then be communicated to the controller. The guide pins 84 not being displaced may be indicative that the no secondary inflator tool 62 is coupled to the primary inflator tool 48. The guide pins 84 being displaced by the desired distance may be indicative that the one of the secondary inflator tools 62 is properly coupled to the primary inflator tool 48. The guide pins 84 being displaced by an undesired distance may be indicative that there is misalignment of one of the secondary inflator tools 62 and the primary inflator tool 48, or that there is some other obstruction.

The primary inflator tool 48 may define one or more first channels or passages 88 that are configured to direct the compressed air into the tires 42 of the wheel assemblies 40. The secondary inflator tools 62 define one or more second passages 90 that are configured to direct the compressed air from the one or more first passages 88 and into the tires 42 of the wheel assemblies 40 when the secondary inflator tools 62 are coupled to the primary inflator tool 48. The air flow through the one or more first passages 88 is illustrated by arrows 92 while the air flow through the one or more second passages 90 is illustrated by arrows 94. Seals 96 may be secured to the top surfaces of the secondary inflator tools 62. When one of the secondary inflator tools 62 is coupled to the primary inflator tool 48 and is in the operational position 78, the corresponding seal 96 is disposed between the primary inflator tool 48 and secondary inflator tool 62 to prevent leakage between the primary inflator tool 48 and secondary inflator tool 62 and to facilitate directing air from the one or more first passages 88 to the one or more second passages 90.

The primary inflator tool 48 is configured to engage wheel assemblies 40 with rims 44 having diameters that are greater than a threshold value and the secondary inflator tools 62 are configured to engage wheel assemblies 40 with rims having diameters that are less than the threshold value. Stated in other terms, the primary inflator tool 48 is larger than the secondary inflator tools 62 and is sized to inflate tires 42 of wheel assemblies 40 with rims having diameters that are greater than a threshold value while the secondary inflator tools 62 are configured to engage wheel assemblies 40 with rims having diameters that are less than the threshold value. More specifically, the primary inflator tool 48 has a ring 98 that compress the sidewalls of the tires 42 during the inflation process while the secondary inflator tools 62 have rings 100 that compress the sidewalls of the tires 42 during the inflation process. The space defined within the rings 98, 100 is configured to receive top portions of the rims during the inflation process. The inner diameter D₁ of ring 98 is larger than the inner diameters of D₂ of ring 100 such that the primary inflator tool 48 can receive rims of a larger diameter relative to the secondary inflator tools 62. In the example where a tertiary inflator tool is included, the tertiary inflator tool may have a ring with an inner diameter that is smaller than inner diameter of D₂. In such an example, a secondary inflator tool 62 can receive rims of a larger diameter relative to the tertiary inflator tool.

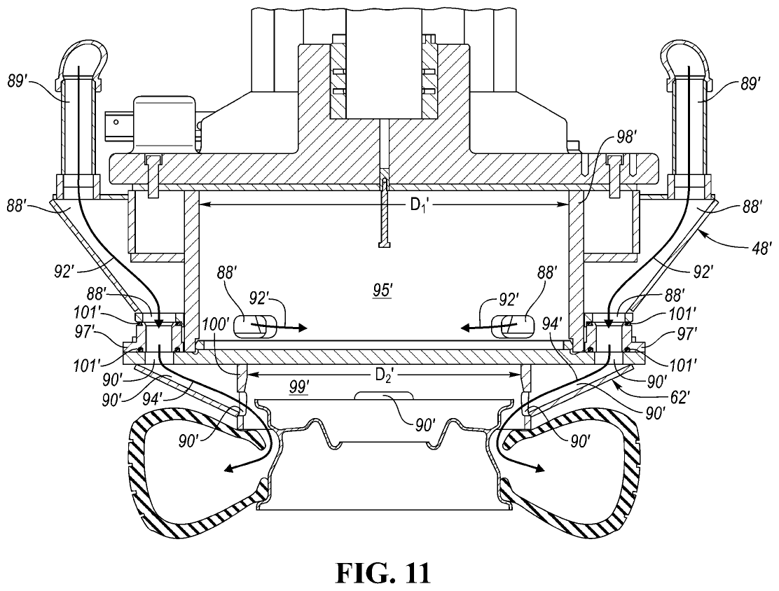

Referring to FIG. 11, an alternative configuration of the primary inflator tool 48′ and one of the secondary inflator tools 62′ is illustrated. If there are two secondary inflator tools 62′, one of the secondary inflator tools 62′ may be referred to as a tertiary inflator tool. It should be understood that the primary inflator tool 48′ and the secondary inflator tools 62′ have all the same subcomponents and functionality the primary inflator tool 48 and the secondary inflator tools 62, unless otherwise stated herein.

It should also be understood that although an element may not be illustrated in FIG. 11, such an element may nevertheless be included as part of either the primary inflator tool 48′ and the secondary inflator tools 62′. For example, alignment elements may be utilized to ensure secondary inflator tools 62′ are properly secured to and properly aligned with the primary inflator tool 48′ when one of the secondary inflator tools 62′ is being utilized. Additional elements may be utilized to determine if the secondary inflator tools 62′ are present (e.g., connected to the primary inflator tool 48′) when being utilized. Other elements could be included such as the clamps 80 may be secured to the primary inflator tool 48′ to detachably couple the secondary inflator tools 62′ to the primary inflator tool 48′. As another example, the guide pins 84 may be secured to the primary inflator tool 48′; a biasing element (e.g., a spring) may bias the guide pins 84 downward; the posts 82 may be secured to the secondary inflator tools 62′; the posts 82 may define locating orifices 86; the guide pins 84 may have ends or tips that are disposed within the locating offices 86 of one of the secondary inflator tools 62′ when the secondary inflator tool 62′ is coupled to the primary inflator tool 48′; shoulders of the guide pins 84 may engage top surfaces of the posts 82′ when one of the secondary inflator tools 62′ is coupled to the primary inflator tool 48′; the top surfaces of the posts 82 engaging the shoulders on the guide pins 84 may push the guide pins 84 upward and displace the guide pins 84 over a desired distance; proximity sensors may detect whether or not the guide pins 84 have been not displaced, have been displaced by the desired distance, or have been displace by an undesired distance, which may then be communicated to the controller; the guide pins 84 not being displaced may be indicative that the no secondary inflator tool 62′ is coupled to the primary inflator tool 48′; the guide pins 84 being displaced by the desired distance may be indicative that the one of the secondary inflator tools 62′ is properly coupled to the primary inflator tool 48′; the guide pins 84 being displaced by an undesired distance may be indicative that there is misalignment of one of the secondary inflator tools 62′ and the primary inflator tool 48′, or that there is some other obstruction.

Furthermore, it should be understood that any component having a callout number in FIG. 11 that includes a prime symbol (′) should be construed as having the same structure, subcomponents, and functionality as a component illustrated in FIGS. 1-10 that includes the same callout number but without the prime symbol, unless otherwise stated herein.

The primary inflator tool 48′ may define one or more first channels or passages 88′ that are configured to received compressed air from conduits 89′ and direct the compressed air into the tires 42 of the wheel assemblies 40. The secondary inflator tools 62′ define one or more second channels or passages 90′ that are configured to direct the compressed air from the one or more first passages 88′ and into the tires 42 of the wheel assemblies 40 when the secondary inflator tools 62′ are coupled to the primary inflator tool 48′. The air flow through the one or more first passages 88′ is illustrated by arrows 92′ while the air flow through the one or more second passages 90′ is illustrated by arrows 94′. If a secondary inflator tool 62′ is not connected to the primary inflator tool 48′ the compressed air is directed to an inner chamber 95′ defined the primary inflator tool 48′ via the one or more first passages 88′ and then into the tires 42 of the wheel assemblies 40. If a secondary inflator tool 62′ is connected to the primary inflator tool 48′, the compressed air is directed within the one or more first passages 88′ along an exterior of the primary inflator tool 48′ and into the one or more second passages 90′ along the exterior of the secondary inflator tools 62′ via one or more conduits or connectors 97′. The compressed air is then directed to an inner chamber 99′ defined the secondary inflator tools 62′ via the one or more second passages 90′ and then into the tires 42 of the wheel assemblies 40.

The connectors 97′ may define an inner channel or passage that direct the air from the one or more first passages 88′ to the one or more second passages 90′. The connectors 97′ may be secured to the secondary inflator tools 62′. The one or more first passages 88′ that are connected or are in fluid communication with the connectors 97′ may be capped or plugged when the secondary inflator tool 62′ is not connected to the primary inflator tool 48′ so that the compressed air is solely or primarily directed from the one or more first passages 88′ and toward the inner chamber 95′.

Seals 101′ may be secured to the top and bottom of the connectors 97′. The seals may more specifically be defined in grooves defined along the top and bottom surfaces of the connectors 97′. When one of the secondary inflator tools 62′ is coupled to the primary inflator tool 48′ and is in the operational position, the corresponding seals 101′ along the top of the connectors 97′ are disposed between the primary inflator tool 48′ and the connectors 97′ while the corresponding seals 101′ along the bottom of the connectors 97′ are disposed between the secondary inflator tool 62′ and the connectors 97′ to prevent leakage between the primary inflator tool 48′ and secondary inflator tool 62′ along the connectors 97′ and to facilitate directing air from the one or more first passages 88′ to the one or more second passages 90′.

The primary inflator tool 48′ is configured to engage wheel assemblies 40 with rims 44 having diameters that are greater than a threshold value and the secondary inflator tools 62′ are configured to engage wheel assemblies 40 with rims having diameters that are less than the threshold value. Stated in other terms, the primary inflator tool 48′ is larger than the secondary inflator tools 62′ and is sized to inflate tires 42 of wheel assemblies 40 with rims 44 having diameters that are greater than a threshold value while the secondary inflator tools 62′ are configured to engage wheel assemblies 40 with rims having diameters that are less than the threshold value. More specifically, the primary inflator tool 48′ has a ring 98′ that compress the sidewalls of the tires 42 during the inflation process while the secondary inflator tools 62′ have rings 100′ that compress the sidewalls of the tires 42 during the inflation process. The space defined within the rings 98′, 100′ (e.g., inner chamber 95′ and inner chamber 99′) is configured to receive top portions of the rims during the inflation process. The inner diameter D₁′ of ring 98′ is larger than the inner diameters of D₂′ of rings 100′ such that the primary inflator tool 48′ can receive rims of a larger diameter relative to the secondary inflator tools 62′. In the example where a tertiary inflator tool is included, the tertiary inflator tool may have a ring with an inner diameter that is smaller than inner diameter of D₂′. In such an example, a secondary inflator tool 62′ can receive rims of a larger diameter relative to the tertiary inflator tool.

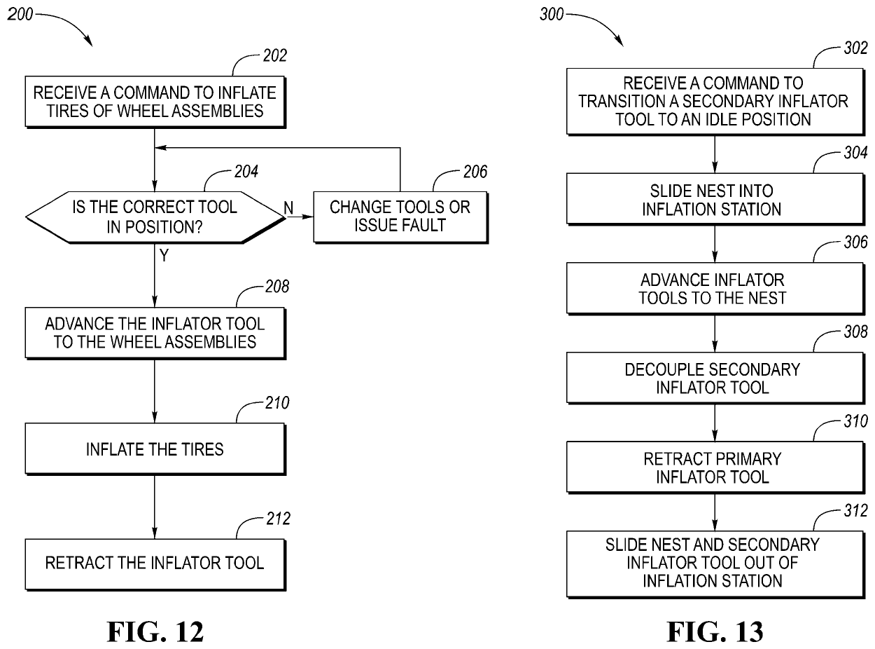

Referring to FIG. 12, a method 200 of operating the inflator tools (e.g., the primary inflator tool 48 and/or the secondary inflator tools 62) is illustrated. The method 200 may be stored as control logic and/or an algorithm within the controller 36. The controller 36 may implement the method 200 by controlling the various components of inflation station 28 and/or the tooling nesting system 30. The method 200 is initiated at block 202 once a command is received to inflate the tires 42 of the wheel assemblies during inflation cycles. The command may be generated by an operator engaging the HMI 38 and starting the wheel assembly system 20. Such a command may place the wheel assembly system 20 into an automated mode where the steps of the various stations (e.g., mounting station, inflation station 28, and unload station), the tooling nesting system 30, and the conveyance system 26 are performed automatically as long as wheel assemblies are loaded into the wheel assembly system 20.

The method 200 next moves on to block 204 where it is determined if the correct tool is in position. More specifically, at block 204 it is determined if the primary inflator tool 48 or if one of the secondary inflator tools 62 are required to properly inflate the tires 42 of the wheel assemblies 40 and if the proper tool (i.e., the primary inflator tool 48 or one of the secondary inflator tools 62) is in position based on the sizes of the rims 44 of the wheel assemblies 40. If the proper tool is not in position, the method 200 moves on to block 206 where the tools may be exchanged so that the proper tool is in position, or a fault may be issued and the automated process may stop until the proper tool is put into place and the automated process is restarted. The sensors 77 detecting the absence of one of the secondary inflator tools 62 when the diameter of the rim of the wheel assembly in the inflation station 28 is greater than the threshold value (indicating that the primary inflator tool 48 is the proper tool) may result in a transition to block 206. The sensors 77 detecting the presence of one of the secondary inflator tools 62 when the diameter of the rim of the wheel assembly in the inflation station 28 is less than the threshold value (indicating that one of the secondary inflator tools 62 is the proper tool) may result in a transition to block 206.

If the proper tool is in position, the method 200 moves on to block 208. The transition to block 208 may occur immediately after block 204 if the proper tool is in position or may occur after the proper tool was exchanged at block 206, which may include restarting the automated process after clearing a fault. At block 208, the inflator tool or tools are advanced to the wheel assemblies 40. In the event the secondary inflator tools 62 are in the idle positions 76, the primary inflator tool 48 is advanced downward to the engaged position 50 and to the wheel assemblies 40 at block 208. In the event one of the secondary inflator tools 62 is in the operational position 78, the primary inflator tool 48 and the secondary inflator tool 62 that is in the operational position 78 are collectively advanced downward to the engaged position 50 and to the wheel assemblies 40 at block 208.

Next, the method 200 moves on to block 210, where the tires 42 are inflated. In the event the secondary inflator tools 62 are in the idle positions 76 the primary inflator tool 48 directs air into the tires 42 via the one or more first passages 88 at block 210. In the event one of the secondary inflator tools 62 is in the operational position 78, the primary inflator tool 48 and the secondary inflator tool 62 collectively direct air into the tires 42 via the one or more first passages 88 and the one or more second passages 90 at block 210. The method 200 then moves on to block 212 where the inflator tool or tools are retracted from the wheel assemblies 40. In the event the secondary inflator tools 62 are in the idle positions 76, the primary inflator tool 48 is retracted upward to the disengaged position 52 at block 212. In the event one of the secondary inflator tools 62 is in the operational position 78, the primary inflator tool 48 and the secondary inflator tool 62 are collectively retracted upward to the disengaged position 52 at block 212.

Referring to FIG. 13, a method 300 of decoupling inflator tools (e.g., the primary inflator tool 48 and the secondary inflator tools 62) is illustrated. The method 300 may be stored as control logic and/or an algorithm within the controller 36. The controller 36 may implement the method 300 by controlling the various components of inflation station 28 and/or the tooling nesting system 30. The method 300 is initiated at block 302 where a command to transition one the secondary inflator tools 62 to the idle position 76 is received. The command may be generated by an operator engaging the HMI 38 or may occur automatically when a change in size of the wheel assemblies 40 being loaded into the wheel assembly system 20 is detected facilitating a change in inflator tools. Next the method 300 moves on to block 304 where the nest 60 corresponding to the secondary inflator tool 62 is operated to move into the advanced position 64 and into the inflation station 28. Next, at block 306 the primary inflator tool 48 and the secondary inflator tool 62 that is coupled to the primary inflator tool 48 are collectively advanced downward to the nest 60 such that the secondary inflator tool 62 is positioned on the nest 60. The secondary inflator tool 62 is then decoupled from the primary inflator tool 48 via opening the clamps 80 at block 308. The primary inflator tool 48 is then retracted to the disengaged position 52 at block 310. The nest 60 and the corresponding secondary inflator tool 62 are the collectively transitioned out of the inflation station 28 and to the retracted position 66 at block 312.

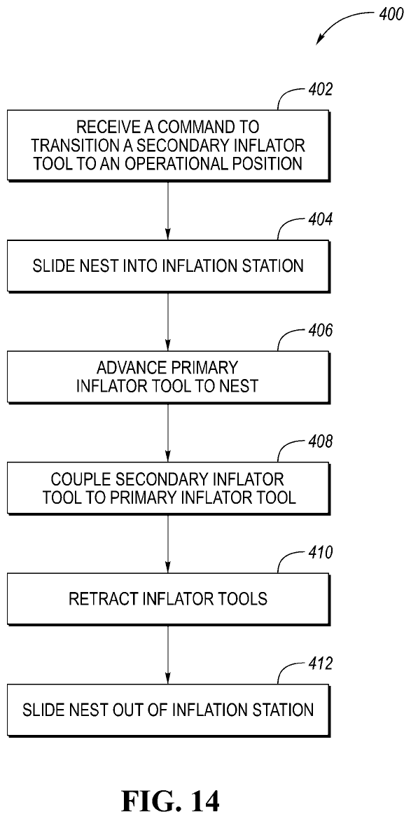

Referring to FIG. 14, a method 400 of coupling inflator tools (e.g., the primary inflator tool 48 and the secondary inflator tools 62) is illustrated. The method 400 may be stored as control logic and/or an algorithm within the controller 36. The controller 36 may implement the method 400 by controlling the various components of inflation station 28 and/or the tooling nesting system 30. The method 400 is initiated at block 402 where a command to transition one the secondary inflator tools 62 to the operational position 78 is received. The command may be generated by an operator engaging the HMI 38 or may occur automatically when a change in size of the wheel assemblies 40 being loaded into the wheel assembly system 20 is detected facilitating a change in inflator tools. Next the method 400 moves on to block 404 where the nest 60, having a corresponding secondary inflator tool 62 disposed thereon, is operated to move into the advanced position 64 and into the inflation station 28. Next, at block 406 the primary inflator tool 48 is advanced downward to the nest 60 such that the primary inflator tool 48 engages the secondary inflator tool 62. The secondary inflator tool 62 is then coupled from the primary inflator tool 48 via closing the clamps 80 at block 408. The primary inflator tool 48 and the secondary inflator tool 62 are then collectively retracted to the disengaged position 52 at block 410. The nest 60 is then transitioned out of the inflation station 28 and to the retracted position 66 at block 412.

It should be understood that the flowcharts in FIGS. 12-14 are for illustrative purposes only and that the methods should not be construed as limited to the flowcharts in FIGS. 11-13. Some of the steps of the methods may be rearranged while others may be omitted entirely. It should also be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. An inflation system for wheel assemblies having tires and rims comprising:
an inflation station having (i) an overhead frame and (ii) a primary inflator tool, wherein the primary inflator tool defines a first passage and is movably secured to the overhead frame;
a nesting fixture disposed adjacent to the inflation station and configured to move into and out of the inflation station;
a secondary inflator tool defining a second passage, wherein the secondary inflator tool is configured to be (i) positioned on the nesting fixture in an idle position and (ii) detachably coupled to the primary inflator tool in an operational position; and
a controller programmed to, in response to a command to transition the secondary inflator tool from the idle position to the operational position, move the nesting fixture into the inflation station and couple the secondary inflator tool to the primary inflator tool.

2. The inflation system of claim 1, wherein the controller is further programmed to, in response to the command to transition the secondary inflator tool from the idle position to the operational position and moving the nesting fixture into the inflation station, advance the primary inflator tool to the nesting fixture prior to coupling the secondary inflator tool to the primary inflator tool.

3. The inflation system of claim 1, wherein the controller is further programmed to, in response to the command to transition the secondary inflator tool from the idle position to the operational position and coupling the secondary inflator tool to the primary inflator tool, collectively retract the primary and secondary inflator tools from the nesting fixture.

4. The inflation system of claim 3, wherein the controller is further programmed to, in response to collectively retracting the primary and secondary inflator tools from the nesting fixture, move the nesting fixture out of the inflation station.

5. The inflation system of claim 1, wherein the controller is further programmed to, in response to a command to transition the secondary inflator tool from the operational position to the idle position, move the nesting fixture into the inflation station and decouple the secondary inflator tool from the primary inflator tool.

6. The inflation system of claim 5, wherein the controller is further programmed to, in response to the command to transition the secondary inflator tool from the operational position to the idle position and moving the nesting fixture into the inflation station, collectively advance the primary and secondary inflator tools to the nesting fixture prior to decoupling the secondary inflator tool to the primary inflator tool.

7. The inflation system of claim 5, wherein the controller is further programmed to, in response to the command to transition the secondary inflator tool from the operational position to the idle position and decoupling the secondary inflator tool from the primary inflator tool, retract the primary inflator tool from the nesting fixture.

8. The inflation system of claim 7, wherein the controller is further programmed to, in response retracting the primary inflator tool from the nesting fixture, collectively move the nesting fixture and the secondary inflator tool out of the inflation station.

9. The inflation system of claim 1, wherein the controller is further programmed to,
in response to commands to inflate the tires during inflation cycles and the secondary inflator tool being in the idle position, (i) advance the primary inflator tool downward to the wheel assemblies and direct air into the tires via the first passage during each inflation cycle and (ii) retract the primary inflator tool away from the wheel assemblies between the inflation cycles, and
in response to the commands to inflate the tires during inflation cycles and the secondary inflator tool being in the operational position, (i) collectively advance the primary and secondary inflator tools to the wheel assemblies and direct air into the tires collectively via the first and second passages during each inflation cycle and (ii) collectively retract the primary and secondary inflator tools from the wheel assemblies between inflation cycles.

10. The inflation system of claim 9, wherein the primary inflator tool is configured to engage wheel assemblies with rims having diameters within a first range of values and the secondary inflator tool is configured to engage wheel assemblies with rims having diameters within a second range of values, wherein the first range of values is different from the second range of values.

11. The inflation system of claim 9, wherein at least one seal is disposed between the primary and secondary inflator tools while the secondary inflator tool is in the operational position to prevent leakage between the primary and secondary inflator tools and to facilitate directing air from the first passage to the second passage.

12. The inflation system of claim 1 further comprising clamps secured to the primary inflator tool and configured to detachably couple the secondary inflator tool to the primary inflator tool.

13. The inflation system of claim 12, wherein (i) the secondary inflator tool includes posts extending upward therefrom and (ii) the clamps are configured to engage and disengage the posts to couple and decouple the secondary inflator tool to and from the primary inflator tool.

14. An inflation system for wheel assemblies having tires and rims comprising:
an inflation station having (i) an overhead frame and (ii) a primary inflator tool, wherein the primary inflator tool defines a first passage and is movably secured to the overhead frame;
a nesting fixture disposed adjacent to the inflation station and configured to move into and out of the inflation station;
a secondary inflator tool defining a second passage, wherein the secondary inflator tool is configured to be (i) positioned on the nesting fixture in an idle position and (ii) detachably coupled to the primary inflator tool in an operational position; and
a controller programmed to, in response to a command to transition the secondary inflator tool from the operational position to the idle position, move the nesting fixture into the inflation station and decouple the secondary inflator tool from the primary inflator tool.

15. The inflation system of claim 14, wherein the controller is further programmed to, in response to the command to transition the secondary inflator tool from the operational position to the idle position and moving the nesting fixture into the inflation station, collectively advance the primary and secondary inflator tools to the nesting fixture prior to decoupling the secondary inflator tool to the primary inflator tool.

16. The inflation system of claim 14, wherein the controller is further programmed to, in response to the command to transition the secondary inflator tool from the operational position to the idle position and decoupling the secondary inflator tool from the primary inflator tool, retract the primary inflator tool from the nesting fixture.

17. The inflation system of claim 16, wherein the controller is further programmed to, in response retracting the primary inflator tool from the nesting fixture, collectively move the nesting fixture and the secondary inflator tool out of the inflation station.

18. The inflation system of claim 14, wherein the controller is further programmed to, in response to a command to transition the secondary inflator tool from the idle position to the operational position, move the nesting fixture into the inflation station and couple the secondary inflator tool to the primary inflator tool.

19. The inflation system of claim 18, wherein the controller is further programmed to, in response to the command to transition the secondary inflator tool from the idle position to the operational position and moving the nesting fixture into the inflation station, advance the primary inflator tool to the nesting fixture prior to coupling the secondary inflator tool to the primary inflator tool.

20. The inflation system of claim 18, wherein the controller is further programmed to, in response to the command to transition the secondary inflator tool from the idle position to the operational position and coupling the secondary inflator tool to the primary inflator tool, collectively retract the primary and secondary inflator tools from the nesting fixture.

21. The inflation system of claim 20, wherein the controller is further programmed to, in response to collectively retracting the primary and secondary inflator tools from the nesting fixture, move the nesting fixture out of the inflation station.

22. The inflation system of claim 14, wherein the controller is further programmed to,
in response to commands to inflate the tires during inflation cycles and the secondary inflator tool being in the idle position, (i) advance the primary inflator tool downward to the wheel assemblies and direct air into the tires via the first passage during each inflation cycle and (ii) retract the primary inflator tool away from the wheel assemblies between the inflation cycles, and
in response to the commands to inflate the tires during inflation cycles and the secondary inflator tool being in the operational position, (i) collectively advance the primary and secondary inflator tools to the wheel assemblies and direct air into the tires collectively via the first and second passages during each inflation cycle and (ii) collectively retract the primary and secondary inflator tools from the wheel assemblies between inflation cycles.

23. The inflation system of claim 22, wherein the primary inflator tool is configured to engage wheel assemblies with rims having diameters within a first range of values and the secondary inflator tool is configured to engage wheel assemblies with rims having diameters within a second range of values, wherein the first range of values is different from the second range of values.

24. The inflation system of claim 23 further comprising a sensor secured to the nesting fixture and configured to detect the presence or the absence of the secondary inflator tool, and wherein the controller is further programmed to,
in response to a first wheel assembly disposed within the inflation station where the first wheel assembly has a first rim with a first diameter that within the first range of values and the sensor detecting the absence of the secondary inflator tool, override advancing the primary inflator tool and issue a fault command, and
in response to a second wheel assembly disposed within the inflation station where the second wheel assembly has a second rim with a second diameter that within the second range of values and the sensor detecting the presence of the secondary inflator tool, override collectively advancing the primary and secondary inflator tools and issue a fault command.

25. The inflation system of claim 22, wherein at least one seal is disposed between the primary and secondary inflator tools while the secondary inflator tool is in the operational position to prevent leakage between the primary and secondary inflator tools and to facilitate directing air from the first passage to the second passage.

26. The inflation system of claim 14 further comprising clamps secured to the primary inflator tool and configured to detachably couple the secondary inflator tool to the primary inflator tool.

27. The inflation system of claim 26, wherein (i) the secondary inflator tool includes posts extending upward therefrom and (ii) the clamps are configured to engage and disengage the posts to couple and decouple the secondary inflator tool to and from the primary inflator tool.

28. An inflation system for wheel assemblies having tires and rims comprising:
a primary inflator tool configured to (i) advance toward the wheel assemblies, (ii) engage the wheel assemblies, (ii) inflate the tires of the wheel assemblies, and (iv) retract from the wheel assemblies after inflating the tires;
a nest configured to transition between first and second positions, wherein in the first position the nest is aligned with the primary inflator tool and in the second position the nest is offset from the primary inflator tool;
a secondary inflator tool configured to be (i) positioned on the nest in an idle position and (ii) detachably coupled to the primary inflator tool in an operational position; and
clamps secured to the primary inflator tool and configured to detachably couple the secondary inflator tool to the primary inflator tool.

29. The inflation system of claim 28 further comprising a controller programmed to,
in response to a command to transition the secondary inflator tool from the idle position to the operational position, transition the nest to the first position and couple the secondary inflator tool to the primary inflator tool via closing the clamps, and
in response to a command to transition the secondary inflator tool from the operational position to the idle position, transition the nest to the first position and decouple the secondary inflator tool from the primary inflator tool via opening the clamp.

30. The inflation system of claim 29 further comprising a second nest configured to transition between third and fourth positions, wherein (i) in the third position the second nest is aligned with the primary inflator tool and (i) in the fourth position the second nest is offset from the primary inflator tool.

31. The inflation system of claim 30 further comprising a tertiary inflator tool configured to be (i) positioned on the second nest in a second idle position and (ii) detachably coupled to the primary inflator tool in a second operational position.

32. The inflation system of claim 31 further comprising a controller programmed to,
in response to a command to transition the tertiary inflator tool from the second idle position to the second operational position, transition the second nest to the third position and couple the tertiary inflator tool to the primary inflator tool via closing the clamps, and
in response to a command to transition the tertiary inflator tool from the second operational position to the second idle position, transition the second nest to the third position and decouple the tertiary inflator tool from the primary inflator tool via opening the clamps.
